(19) United States
(12) Patent Application Publication
(10) Pub. No.: US 2004/0194375 A1
(43) Pub. Date: Oct. 7, 2004

(54) Methods and apparatus for lettuce harvesting facilitation

(75) Inventors: Richard Brown, Salinas, CA (US); Tim Wexler, Salinas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Fresh Express, Inc., Salinas, CA

(21) Appl. No.: 10/803,742

(22) Filed: Mar. 17, 2004

Related U.S. Application Data
(63) Continuation of application No. 10/281,295, filed on Oct. 25, 2002, now abandoned.

(51) Int. Cl. A01G 13/02; A47G 7/08

(52) U.S. Cl. 47/58.1 R

(57) ABSTRACT

A method of controlling the environment of a field of plants. The method includes providing a movable cover and moving the cover the cover over the field of plants. The cover is left over the field of plants for an amount of time to control at least one parameter of the environment of the field of plants. The cover is then removed from at least a portion of the field of plants and at least some harvesting is done from at least some of the plants in the field of plants. The parameters include temperature, light and parasites.

### CROSS-REFERENCES TO RELATED APPLICATIONS

NOT APPLICABLE

### STATEMENT AS TO RIGHTS TO INVENTIONS MADE UNDER

FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

1. Field of the Invention

The present invention relates to systems and methods for facilitating lettuce harvesting, and more particularly, to systems and methods for controlling the environment in a field of leafy plants in order to help prevent freezing, premature ripening, and bug damage to the leafy plants.

2. Description of the Prior Art

The demand for leafy vegetables, such as, for example, lettuce, spinach, cabbage, baby leaves, baby lettuce, baby spinach, etc., has greatly increased over the years. Salads are now often in high demand for meals, whether as an entree, a side dish or an appetizer. Thus, lettuce is generally grown and harvested year-round in various parts of the United States.

During the colder months, lettuce is generally grown and harvested in warmer areas of North America, including Arizona, Southern California and Mexico. However, at night in these locales, it can still get very cold. Indeed, often just before dawn, it is the coldest. In fact, it can be at, below or at least near freezing at this time. Such cold temperatures can lead to freezing of the lettuce or other leafy plants. Indeed, temperatures are generally coldest from ground level to six to eight above ground level.

If the plants are frozen or ice is forming or has formed in the leaves, or close thereto, they cannot be harvested. This is because the leaves may crack or break, thus damaging the plants. Additionally, they may simply bruise, which leads to decay of the leaves after harvesting. Accordingly, until the leafy plants thaw, they should not be harvested. However, crews generally arrive around dawn in order to take advantage of as much daylight as possible in harvesting the leafy plants. Thus, if the plants are frozen and the crews need to wait until the plants thaw, then valuable labor time is lost as they stand around waiting to harvest the plants. This causes problems all along the lettuce “production” line. Such delays in harvesting lead to delays in vacuum cooling of the lettuce, delays in trucking of the lettuce, delays in processing the lettuce at a salad processing plant and thus, delays in providing the lettuce to customers, thereby causing bad customer relations. Indeed, in order to avert these problems, overtime wages may need be paid. However, even this still may not alleviate the delay in supplying the lettuce to the customer.

Currently, it is estimated that an acre of leafy plants is worth about $3,000.00. If the plants are damaged or cannot be harvested, this is a high cost. Likewise, the converse is true, in that if delays in harvesting lettuce occurs, then acres of lettuce may ripen and may be ready for harvesting, but due to the delays, the labor cannot get to the other acres of lettuce. This then leads to the disking of the field and the destruction of the leafy plants in the field, thereby resulting in the loss of the estimated $3,000.00 per acre.

Accordingly, it would be desirable to control the environment around the leafy plants in order to facilitate harvesting thereof.

### SUMMARY OF THE INVENTION

The present invention provides a method of controlling the environment of a field of plants. The method includes providing a movable cover and moving the cover over the field of plants. The cover is left over the field of plants for an amount of time to control at least one parameter of the environment of the field of plants. The cover is then removed from at least a portion of the field of plants and at least some harvesting is done from at least some of the plants in the field of plants.

In accordance with one aspect of the present invention, the at least one parameter is from a group comprising temperature, atmosphere and light.

In accordance with another aspect of the present invention, air is supplied under the cover.

In accordance with a further aspect of the present invention, the air is heated.

In accordance with another aspect of the present invention, two covers are provided and moved over the field of plants. The two covers are left over the field of plants and then removed from the field of plants prior to harvesting.

In accordance with a further aspect of the present invention, air is supplied under the covers.

In accordance with a further aspect of the present invention, air is supplied between the covers.

In accordance with a further aspect of the present invention, shade cloth is provided over the field of plants in order to slow growth of the field of plants. The shade cloth also helps keep bugs off the plants.

Accordingly, the present invention provides systems and methods for controlling the environment of fields of plants. The present invention helps protect the plants from elements of nature, including extreme heat, cold, light, and bugs, and helps prevent ice formation in the leaves of the plants. Furthermore, the present invention provides happier leafy plants. The leaves are generally more crisp and turgid. More moisture is kept in the plant and therefore, the plants weigh more, which may mean more money for the farmer and harvester since the harvested plants are generally sold by weight.

The preferred exemplary embodiments of this invention will now be discussed in detail. These embodiments depict the novel and nonobvious environment controlling systems and methods of this invention shown in the accompanying drawings, which are included for illustrative purposes only, with like numerals indicating like elements.

### BRIEF DESCRIPTION OF THE DRAWINGS

FIG. 1 is a plan view of a field of plants with a vehicle placing a cover thereover in accordance with the present invention;

FIG. 2 is a side elevation view of the vehicle in the field of plants in FIG. 1;

FIG. 3 is an enlarged side elevation view of the vehicle illustrated in FIGS. 1 and 2;

FIG. 4 is an end elevation view of a trailer with rolls of covers in accordance with the present invention; and

FIG. 5 is a perspective view of a spindle for carrying a cover in accordance with the present invention.

### DETAILED DESCRIPTION OF THE INVENTION

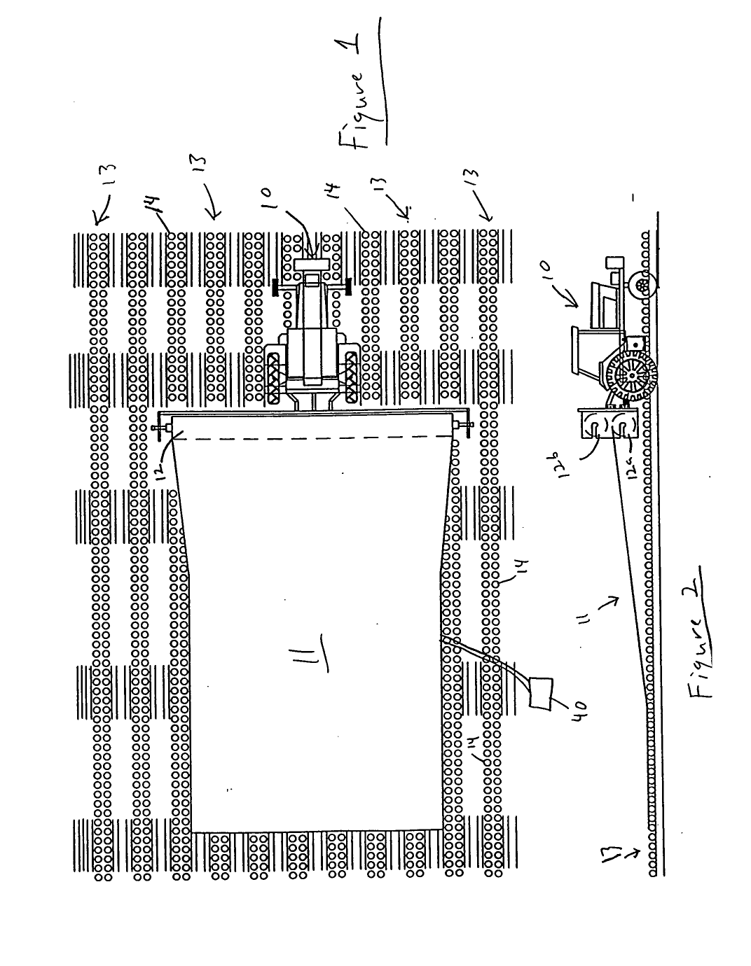

FIG. 1 illustrates a vehicle 10, generally a tractor, distributing or laying a cover 111 within a field of plants for controlling the environment of the field of plants. In FIG. 1, the field with plants consist of beds of lettuce. However, those skilled in the art will understand that the present invention may be used for fields of other types of plants. For simplicity and clarity, the description of the present invention will be with regard to lettuce, but it is not meant to be limiting.

Preferably, the cover is unrolled from rolls 12 that are twenty-four inches in diameter. When fully unrolled, the cover is preferably nine hundred feet long and twenty-five feet wide. Thus, one roll will generally cover approximately six beds 13 of lettuce as can be seen in FIG. 1. This is because each bed of lettuce is approximately forty-two inches from center of furrow to center of furrow, and approximately twenty-two and a half inches for the top of the bed. Thus, the wheels of the vehicle fit between beds of lettuce so that they do not damage the lettuce while spreading the cover.

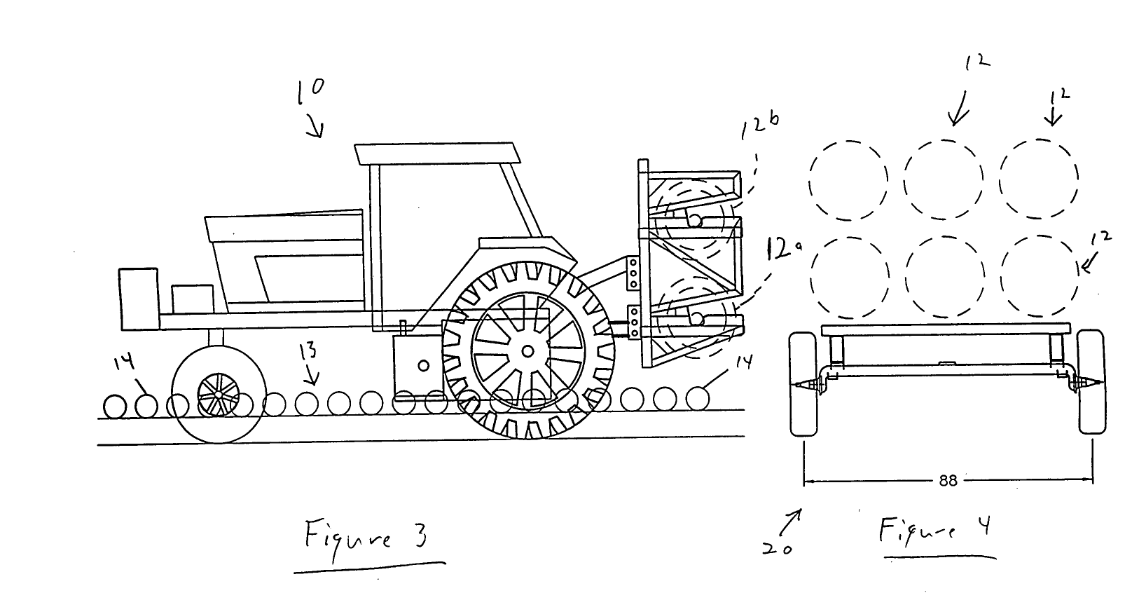

As can be seen in FIGS. 2 and 3, preferably the vehicle contains at least two rolls 12a, 12b of the cover. Thus, with an alternative embodiment of the present invention, two covers may be spread simultaneously over the beds of lettuce, one over the top of the other. Air may be provided between the covers as will be explained more fully herein. Alternatively, no air needs to be pumped between the covers if it is so desired. The second cover will simply provide extra protection for the plants and the two covers will act as an insulator similar to a double pane window due to the air trapped between the two covers.

Preferably, the cover consists of plastic, preferably in a range of four to ten mils thick. Most preferably, the plastic is approximately eight mils thick.

Thus, in accordance with the present invention, at least one cover is placed over beds of plants, such as lettuce, preferably in the late afternoon by the light of day, and preferably the day before harvesting is desired. However, the covers may be placed over the fields at a later time since, often at or just before dawn, it is the coldest during the colder months in areas such as, for example, Arizona, Southern California and Mexico.

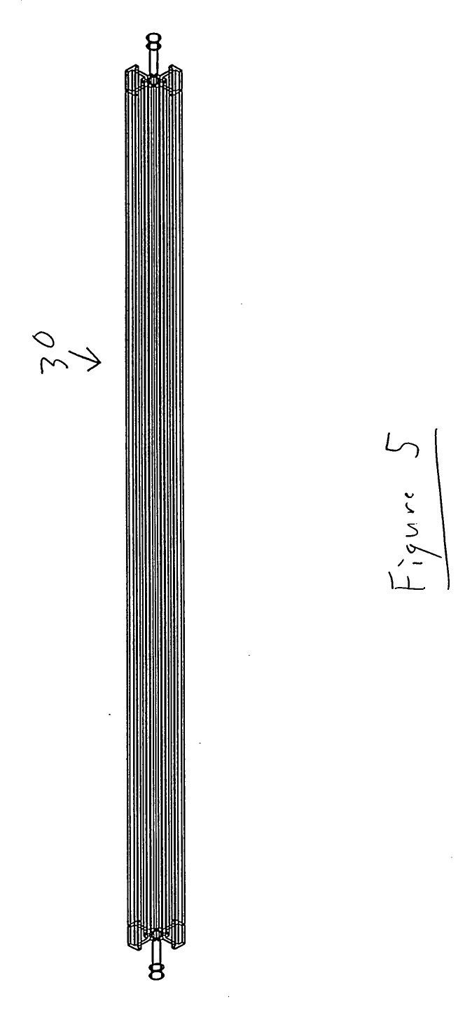

FIG. 4 illustrates a wagon or trailer 20 that may be used to haul extra rolls of the covers to be used for covering fields of plants.

FIG. 5 illustrates an example of a spindle 30 upon which a cover may be rolled.

As can be seen in FIG. 1, air supply 40 may be used to pump air under the cover to help control the temperature under the cover and thereby keep the plants at a desired temperature. Preferably, the air is heated with a heater, which may either be separate or may be part of the air supply. In one embodiment, the heat is supplied by burning propane. Such heat has beneficial effects for the plants because burning of propane, and other gaseous fuels, provides carbon dioxide and water as by-products. These by-products make the leaves of the plants generally more crisp and turgid, thus providing happier, leafy plants. More moisture is also generally kept in the plants, and therefore the plants weigh more, which may mean more money for the farmer and harvester since the harvested plants are generally sold by weight.

If two covers are placed over the field, the air, whether heated or not, may be provided between the covers to help control the temperature and environment of the field of plants at ground level. However, unless the bottom cover is made from a fairly permeable material, the benefits of heated air mentioned above may not be provided. Thus, air, heated or otherwise, may be supplied under the bottom cover.

Once the field is ready to be harvested, the cover(s) are removed. Generally, this occurs at or just after dawn, when it is light enough to see for harvesting and the temperature is warm enough to not damage the plants, i.e., ice formation within the leaves won't occur. Alternatively, lights may be provided so that even if it is dark, harvesting may begin, temperature permitting. Preferably, twenty to forty feet of cover is removed at a time. This may be done by folding the cover, but preferably is done by rolling the covers back on to the spindles from which they were dispensed.

In accordance with a further embodiment of the present invention, a shade cloth may be placed over fields of plants during the day to help control the environment of the plants close to the ground. Such a shade cloth generally consists of plastic or woven plastic and is generally approximately 4 mils thick. Preferably, the shade cloth is once again on rolls that, when fully rolled up have a twenty four inch diameter and fully extended are nine hundred feet long. Thus, one roll would once again cover approximately six beds of plants. The shade cloth is used to help keep the plants from getting too warm, too much sunlight, etc. Generally, the cloth allows some light to pass through and thus, is intentionally restrictive. This helps slow down the growth and maturation of the plants so that the plants are not ready for harvesting before crews are available and ready to harvest the plants.

The shade cloth also provides protection from bugs. Additionally, some type of bug repellant, such as, for example, pesticide, may be provided under the cover.

Thus, fields of plants, such as, for example, lettuce, spinach, cabbage, baby leaves, baby lettuce, baby spinach, etc., may have their environment controlled at ground level by providing covers that control parameters such as, for example, temperature, light, atmosphere, parasites, etc. A cover may be used to control these parameters during portions of the night or day, or all day and/or all night. Additionally, different types of covers may be used based upon the different types of parameters to be controlled and also depending upon the time of the day. Generally, by controlling the environment of the plants and the various parameters, harvesting of the plants may be performed at optimum times when crews are readily available, the weather is cooperative, light is ample, and the plants are mature and ready for harvesting. Furthermore, growth of the crop may be slowed so that it may be harvested at a more economically rewarding time, allowing for avoidance of a “glut” of crop that may lead to waste or the inability to even harvest all of the crop. Plus, the resulting plants are generally happier, healthier, and even larger and more robust.

Although the invention has been described with reference to specific exemplary embodiments, it will appreciated that it is intended to cover all modifications and equivalents within the scope of the appended claims.

What is claimed is:

1. A method of controlling the environment of a field of plants, the method comprising:
providing a movable cover;
moving the cover over the field of plants;
leaving the cover over the field of plants for an amount of time to control at least one parameter of the environment of the field of plants;
removing the cover from at least a portion of the field of plants; and
harvesting from at least some of the plants from the field of plants.

2. A method in accordance with claim 1 wherein the at least one parameter is from a group comprising temperature, atmosphere and light.

3. A method in accordance with claim 1 further comprising supplying air under the cover.

4. A method in accordance with claim 3 wherein the air is heated.

5. A method in accordance with claim 1 wherein two covers are provided, moved over the field of plants, left over the field of plants for the amount of time, and removed from the field of plants.

6. A method in accordance with claim 4 further comprising supplying air under the covers.

7. A method in accordance with claim 6 wherein the air is heated.

8. A method in accordance with claim 4 further comprising supplying air between the covers.

9. A method in accordance with claim 8 wherein the air is heated.

10. A method in accordance with claim 1 wherein pesticide is provided under the cover.

11. A method of facilitating harvesting of leafy plants, the method comprising:
providing a movable cover;
moving the cover over a field of leafy plants prior to dawn of a day that harvesting is desired;
leaving the cover over the field of leafy plants for an amount of time to control at least one parameter of the environment of the field of leafy plants;
removing the cover from at least a portion of the field of leafy plants after dawn of the day harvesting is desired; and
harvesting from at least some of the leafy plants from the field of leafy plants.

12. A method in accordance with claim 11 wherein the leafy plants are at least one of a group comprising lettuce, spinach, cabbage, baby leaves, baby lettuce and baby spinach.

13. A method in accordance with claim 11 wherein the at least one parameter is from a group comprising temperature, atmosphere and light.

14. A method in accordance with claim 11 further comprising supplying air under the cover.

15. A method in accordance with claim 14 wherein the air is heated.

16. A method in accordance with claim 11 wherein two covers are provided, moved over the field of plants, left over the field of plants for the amount of time, and removed from the field of plants.

17. A method in accordance with claim 16 wherein the covers comprise plastic substantially 4 mils thick.

18. A method in accordance with claim 16 further comprising supplying air under the covers.

19. A method in accordance with claim 18 wherein the air is heated.

20. A method in accordance with claim 16 further comprising supplying air between the covers.

21. A method in accordance with claim 20 wherein the air is heated.

22. A method in accordance with claim 11 wherein pesticide is provided under the cover.

23. A method in accordance with claim 11 wherein the cover comprises plastic substantially 4 mils thick.

24. A method in accordance with claim 11 wherein the cover is removed in twenty feet increments.

25. A method in accordance with claim 11 further comprising covering the field of leafy plants with a shade cloth before harvesting.

26. A method of slowing growth of a field of plants, the method comprising placing at least one cover over the plants to limit the amount light reaching the plants.

27. A method in accordance with claim 26 wherein the cover comprises shade cloth approximately 4 mils thick.

28. A method in accordance with claim 27 wherein the cover comprises one of plastic or woven plastic.

29. A method of preventing ice formation in leaves in plants in a field, the method comprising placing at least one cover over the plants prior to dawn of a day the plants are desired to be harvested.

30. A method in accordance with claim 29 wherein the cover comprises plastic.

31. A method in accordance with claim 30 wherein the cover is approximately 8 mils thick.
